(19) United States
(12) Patent Application Publication
(10) Pub. No.: US 2022/0368982 A1
(43) Pub. Date: Nov. 17, 2022

(54) ELECTRONIC DEVICE AND ITS EXECUTION METHOD AND COMPUTER-READABLE MEDIUM

(71) Applicant: ARRIS Enterprises LLC, Suwanee, GA (US)

(72) Inventors: Ye-Yi CUI, Shanghai (CN); Yu-An CHEN, Shanghai (CN); Ji CHEN, Shanghai (CN); Lingfeng HOU, Zhengzhou (CN); Bing YAO, Shanghai (CN)

(21) Appl. No.: 17/714,426

(22) Filed: Apr. 6, 2022

(30) Foreign Application Priority Data
May 14, 2021 (CN) 202110528546.4

(51) Int. Cl. H04N 21/443; H04N 21/442; H04N 21/45; H04N 21/422

(52) U.S. Cl. CPC H04N 21/4436; H04N 21/44222; H04N 21/4532; H04N 21/42201

(57) ABSTRACT

The present disclosure relates to an electronic device and its execution method and a computer-readable medium. An electronic device, comprising: a memory, in which instructions are stored; and a processor, configured to execute the instructions stored in the memory to cause the electronic device to execute the following operations: receiving a request for entering a sleep mode; obtaining expected time to fall asleep; obtaining current volume value and/or current brightness value of a playback device; selecting a decay type; and determining a required amount of change per unit time of the brightness value and/or volume value of the playback device according to the decay type, expected time to fall asleep, and the current volume value and/or current brightness value.

### TECHNICAL FIELD

The present disclosure relates to playback devices in general, and more specifically, to the control of playback devices.

### BACKGROUND ART

Nowadays, people have been widely using various kinds of audio/video playback devices in daily life, such as televisions used together with set top boxes or streaming media devices. These devices provide various kinds of information to people and bring fun to daily life. Various kinds of audio/video playback devices have already been indispensable parts of people's lives. For example, many people use audio/video playback devices to listen to audio or watch videos in their free time, and people can control the audio/video playback devices according to their own needs, such as turning up or down the volume, and turning on or off the audio/video playback devices. For example, people can use a remote controller to control a TV set top box to achieve their own needs.

However, there is still a need to improve the comfort of control of audio/video playback devices.

### SUMMARY OF THE INVENTION

Some aspects of the present disclosure relate to an electronic device, comprising: a memory in which instructions are stored; and a processor configured to execute instructions stored in the memory to cause the electronic device to perform the following operations: receiving a request for entering a sleep mode; obtaining expected time to fall asleep; obtaining current volume value and/or current brightness value of a playback device; selecting a decay type; and determining a required amount of change per unit time of the brightness value and/or volume value of the playback device according to the decay type, expected time to fall asleep, and the current volume value and/or current brightness value.

In some aspects, the request for entering the sleep mode is received from user input.

In some aspects, the request for entering the sleep mode is received from a wearable device that monitors physiological parameters of a user.

In some aspects, the expected time to fall asleep is obtained from user input.

In some aspects, the processor is further configured to execute the instructions stored in the memory to cause the electronic device to carry out the following operation: obtaining physiological parameter values of a user during the sleep mode as sleep history data from a wearable device that monitors the physiological parameters of the user.

In some aspects, the expected time to fall asleep or the decay type is determined based on the sleep history data.

In some aspects, the decay type is selected according to user input.

In some aspects, the decay types include one or more of a linear decay, a parabolic decay, a Gauss decay, and an exponential decay.

Some aspects of the present disclosure relate to an execution method of the electronic device, comprising: receiving a request for entering a sleep mode; obtaining expected time to fall asleep; obtaining current volume value and/or current brightness value of a playback device; selecting a decay type; and determining a required amount of change per unit time of the brightness value and/or volume value of the playback device according to the decay type, expected time to fall asleep, and the current volume value and/or current brightness value.

In some aspects, the request for entering the sleep mode is received from user input.

In some aspects, the request for entering the sleep mode is received from a wearable device that monitors physiological parameters of a user.

In some aspects, the expected time to fall asleep is obtained from user input.

In some aspects, the method further comprises: obtaining physiological parameter values of a user during the sleep mode as sleep history data from a wearable device that monitors the physiological parameters of the user.

In some aspects, the expected time to fall asleep or the decay type is determined based on the sleep history data.

In some aspects, the decay type is selected according to user input.

In some aspects, the decay types include one or more of a linear decay, a parabolic decay, a Gauss decay, and an exponential decay.

Some aspects of the present disclosure relate to a non-transitory computer-readable medium, in which instructions are stored, and the instructions, when executed by a processor of an electronic device, cause the electronic device to perform the following operations: receiving a request for entering a sleep mode; obtaining expected time to fall asleep; obtaining current volume value and/or current brightness value of a playback device; selecting a decay type; and determining a required amount of change per unit time of the brightness value and/or volume value of the playback device according to the decay type, expected time to fall asleep, and the current volume value and/or current brightness value.

Some aspects of the present disclosure relate to an apparatus implemented by an electronic device, including a component for executing a step of the method described above.

### BRIEF DESCRIPTION OF THE ATTACHED DRAWINGS

For a better understanding of the present disclosure and to show how to realize the present disclosure, examples are herein described with reference to the attached drawings, wherein:

FIG. 1 is a schematic diagram of an exemplary electronic device according to an embodiment of the present disclosure;

FIG. 2 is a schematic diagram of an exemplary network environment according to an embodiment of the present disclosure;

FIG. 3 is an exemplary flowchart of a method for an electronic device according to an embodiment of the present disclosure;

FIG. 4 is a schematic diagram of an exemplary decay type according to an embodiment of the present disclosure.

It should be noted that throughout the attached drawings, similar reference numerals and signs refer to corresponding parts.

### SPECIFIC EMBODIMENTS

The following detailed description is made with reference to the attached drawings, and the following detailed description is provided to facilitate comprehensive understanding of various exemplary embodiments of the present disclosure. The following description includes various details to facilitate understanding. However, these details are merely considered as examples, not for limiting the present disclosure. The words and phrases used in the following description are only used to enable a clear and consistent understanding of the present disclosure. In addition, for clarity and brevity, descriptions of well-known structures, functions, and configurations may be omitted. Those of ordinary skill in the art would realize that various changes and modifications can be made to the examples described in the present specification without departing from the gist and scope of the present disclosure.

As stated before, people have been increasingly using various kinds of audio/video playback devices in daily life. For example, people listen to audio programs or watch video programs to relax before falling asleep, and may fall asleep during listening or watching. Especially for some people who have difficulties in falling asleep, playing a video or audio program before falling asleep will make them relax and help them fall asleep. In this case, there may be situations where the listener or viewer has fallen asleep while the audio/video playback device is still playing. Usually, people will set the audio/video playback device to an automatic shutdown mode when they are sleepy and want to sleep. In the automatic shutdown mode, the audio/video playback device will automatically shut down after a predetermined time, and this can avoid the situation where the listener or viewer has fallen asleep and the audio/video playback device cannot be turned off.

However, in an existing automatic shutdown mode, when a predetermined time has passed, the audio/video playback device will immediately shut down, and the audio volume value or the brightness value of the playback screen will immediately drop to zero. This sudden change in the audio volume value or the brightness value of the playback screen may cause interference to the user who has fallen asleep or is about to fall asleep. The user may be awakened and unable to fall asleep or have to turn on the audio/video playback device again to get ready to fall asleep again. Therefore, this automatic shutdown mode is not friendly to users who have difficulties in falling asleep or who are easily awakened. These users cannot use this automatic shutdown mode of the audio/video playback device to help them fall asleep.

The technical solutions of the present disclosure provide a device or a method for automatically turning off an audio device or a video device by gradually changing the brightness value or the volume value to help users fall asleep. In one or more embodiments according to the present disclosure, the change of the brightness value or the volume value may be selected according to different situations. For example, a suitable brightness value or volume value change may be selected according to a user's sleep history data to maximize the help to sleep.

Next, the embodiments of the present disclosure will be described in detail with reference to the attached drawings.

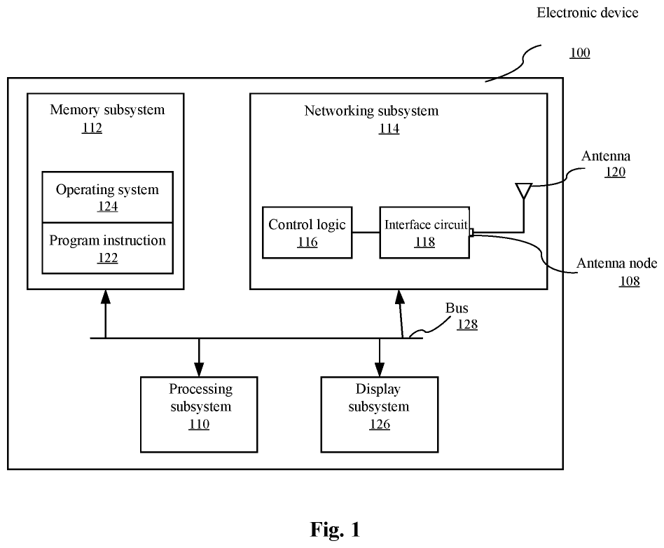

FIG. 1 presents a block diagram illustrating an exemplary electronic device 100 according to some embodiments.

The electronic device 100 may be used to implement various embodiments of the method according to the present disclosure. The electronic device 100 may comprise a processing subsystem 110, a memory subsystem 112, and a networking subsystem 114. The processing subsystem 110 comprises one or a plurality of devices configured to execute computing operations. For example, the processing subsystem 110 may comprise one or a plurality of microprocessors, ASICs, microcontrollers, programmable logic devices, graphics processing units (GPU) and/or one or more digital signal processors (DSPs).

The memory subsystem 112 comprises one or a plurality of devices for storing data and/or instructions used for the processing subsystem 110 and the networking subsystem 114. For example, the memory subsystem 112 may include a dynamic random access memory (DRAM), static random access memory (SRAM), and/or other types of memory (sometimes collectively or individually referred to as “computer-readable storage medium”).

In some embodiments, the memory subsystem 112 is coupled to one or a plurality of high-capacity mass storage devices (not shown). For example, the memory subsystem 112 may be coupled to a magnetic or an optical driver, a solid state driver, or another type of mass storage device. In these embodiments, the electronic device 100 may use the memory subsystem 112 as a fast-access storage of frequently used data, while the mass storage device is used for storing infrequently used data.

The networking subsystem 114 comprises one or a plurality of devices that are configured to be coupled to and/or communicate over wired and/or wireless networks (i.e., to execute network operations), comprising: control logic 116, interface circuit 118, and one or a plurality of antennas 120 (or antenna elements). (Although FIG. 1 includes one or a plurality of antennas 120, in some embodiments, the electronic device 100 includes one or a plurality of nodes, such as node 108, which can be coupled to one or a plurality of antennas 120. Therefore, the electronic device 100 may or may not include one or a plurality of antennas 120.) For example, the networking subsystem 114 may include a Bluetooth networking system, a cellular networking system (for example, 3G/4G/5G networks, such as UMTS, LTE, etc.), a USB networking system, a networking system based on the standards described in IEEE 802.11 (for example, Wi-Fi networking system), Ethernet networking system, and/or another networking system.

In the electronic device 100, a bus 128 is used to couple the processing subsystem 110, the memory subsystem 112, and the networking subsystem 114 together. The bus 128 may comprise electrical, optical, and/or electro-optical connections of the subsystems through which commands, data and the like may be transmitted. Although only one bus 128 is shown for clarity, different embodiments may comprise electrical, optical, and/or electro-optical connections of different numbers or configurations among the subsystems.

In some embodiments, the electronic device 100 includes a display subsystem 126 for showing information on a display device, which may include a display driver and a display, such as a liquid crystal display and a multi-touch screen, etc.

Although specific components are used to describe the electronic device 100, in alternative embodiments, different components and/or subsystems may exist in the electronic device 100. For example, the electronic device 100 may include one or a plurality of additional processing subsystems, memory subsystems, networking subsystems, and/or display subsystems. In addition, the electronic device 100 may not have one or a plurality of the subsystems. Furthermore, in some embodiments, the electronic device 100 may include one or more additional subsystems not shown in FIG. 1. Also, although separate subsystems are shown in FIG. 1, in some embodiments, some or all of the given subsystems or components may be integrated into one or a plurality of the other subsystems or components in the electronic device 100. For example, in some embodiments, a program instruction 122 is included in an operating system 124 and/or the control logic 116 is included in the interface circuit 118.

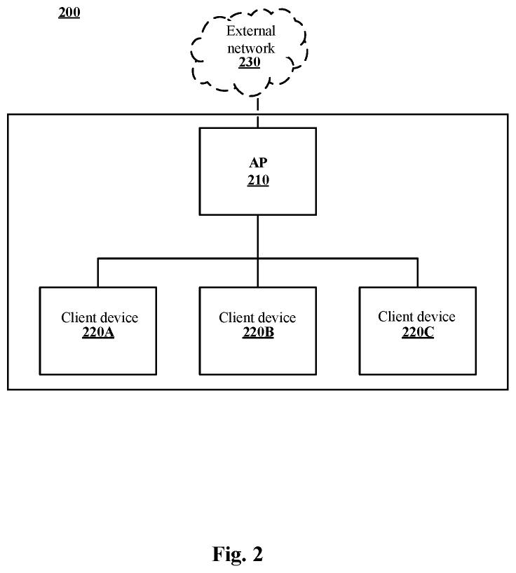

FIG. 2 is a schematic diagram showing an exemplary network environment 100 including the electronic device shown in FIG. 1 according to an embodiment of the present disclosure.

The exemplary network environment 200 may comprise an AP 210 and one or a plurality of client devices 220A, 220B, and 220C (hereinafter, collectively referred to as client device 220 for simplicity). The electronic device 100 shown in FIG. 1 can be implemented as the AP 210 or a part thereof as shown in FIG. 2, or as a client device or a part thereof.

An AP is an access point specified according to the 802.11 protocol, for example. The AP 210 is used to provide wireless network connection for the client device 220. Specifically, the AP 210 may receive/route various types of communications from the client device 220 and/or transmit/route various types of communications to the client device 220. It should be noted that the AP described herein can include routers, gateways, home controllers and other devices with AP functions.

In some embodiments, the client device 220 may be any electronic device having at least one network interface. For example, the client device 220 may be: a desktop computer, a laptop computer, a server, a mainframe computer, a cloud-based computer, a tablet computer, a smart phone, a smart watch, a wearable device, a consumer electronic device, a portable computing device, a radio node, a router, a switch, a repeater, an access point and/or other electronic devices. The client device 220 communicates with the AP 210 using its network interface, thereby accessing the external network 230 via the AP 210. Although three client devices are shown in FIG. 2, it should be understood that the number of client devices that the AP 210 can connect to may be less than or more than three, depending on the network capacity supported by the AP 210.

The external network 230 may be a wide area network (WAN), such as the Internet.

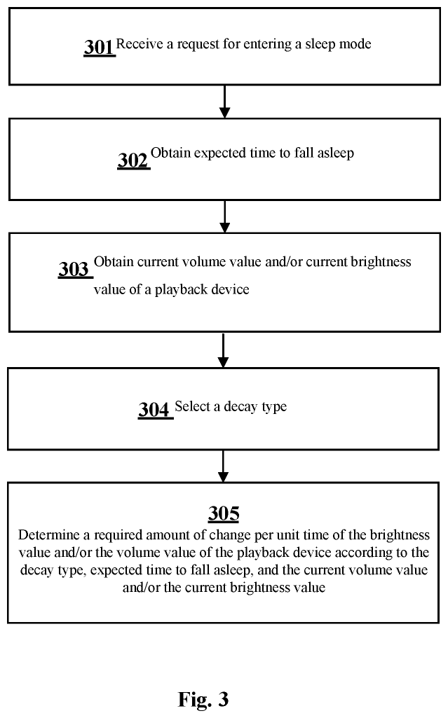

FIG. 3 is a flowchart of a method 300 for an electronic device according to an embodiment of the present disclosure. The method 300 may be used for, for example, the electronic device 100 shown in FIG. 1 or the AP or client device shown in FIG. 2.

As shown in FIG. 3, in 301, a request for entering a sleep mode is received. According to an embodiment of the present disclosure, the request for entering the sleep mode may be received from user input. For example, during listening to an audio program or watching a video program, a user can request to enter the sleep mode when the user is sleepy and wants to sleep but cannot fall asleep immediately. For example, the user can input the request for entering the sleep mode through a remote controller of a television set top box. For another example, when the user's client device (such as a mobile phone) is connected to a playback device, the user can input a request for entering the sleep mode through the client device.

According to another embodiment of the present disclosure, the request for entering the sleep mode may be received from a wearable device that monitors physiological parameters of a user. For example, the user can wear a bracelet that monitors the user's physiological parameters. When the bracelet detects that the user has not moved within a predetermined period of time, or the physiological parameters collected by the bracelet that monitors the user's physiological parameters indicate that the user may be about to fall asleep, the bracelet can send a request for entering the sleep mode to a device executing a method.

Returning to FIG. 3, in 302, the expected time to fall asleep is obtained. According to an embodiment of the present disclosure, the expected time to fall asleep may be obtained from user input. For example, the user can input the expected time to fall asleep by determining the time required to fall asleep according to the user's own habits or an estimation of current sleep conditions. Exemplarily and not restrictively, the time required to fall asleep may be 30 minutes, or any suitable expected time to fall asleep may be selected. After the expected time to fall asleep elapses, the playback device will stop playing or shut down.

In another embodiment according to the present disclosure, physiological parameter values of a user during the sleep mode are obtained as sleep history data from a wearable device that monitors the physiological parameters of the user. The expected time to fall asleep may be determined based on the sleep history data. For example, the sleep history data may include a plurality of recorded values of the time from sending a request for entering the sleep mode by the user to falling asleep. Exemplarily and not restrictively, the average value of the plurality of recorded values may be determined as the expected time to fall asleep. For example, if the sleep history data from a wearable device that monitors the physiological parameters of the user indicates that the user usually falls asleep about 30 minutes after requesting to enter the sleep mode, the expected time to fall asleep may be set to 30 minutes when the user requests to enter the sleep mode next time so as to better suit the user.

Back to FIG. 3, in 303, the current volume value and/or current brightness value of the playback device is obtained. For example, when the playback device is an audio device, only the current volume value is obtained. When the playback device is a video device, the current volume value and the current brightness value may be obtained.

In 304, a decay type is selected. The decay type refers to the way in which the volume value and/or brightness value of the playback device is decreased to enter the shutdown state. According to one or more embodiments of the present disclosure, the decay types may include one or more of a linear decay, a parabolic decay, a Gauss decay, and an exponential decay. In the linear decay, the amount of decrease of the volume value and/or brightness value per unit time is the same. In the exponential decay, the volume value and/or brightness value decreases rapidly at the beginning and then slows down. In the Gauss decay, the volume value and/or brightness value decreases slowly at the beginning and then decreases rapidly. Those skilled in the art will understand that the decay types listed are only exemplary and not restrictive.

According to an embodiment of the present disclosure, the decay type may be selected according to user input. For example, the user may select a suitable decay type according to the user's experience on use.

In another embodiment according to the present disclosure, the decay type may be determined based on the sleep history data. For example, the sleep history data may include a plurality of recorded values of the time from sending a request for entering the sleep mode by the user to falling asleep when a certain decay type is used. Exemplarily and not restrictively, an average time to fall asleep may be determined corresponding to the used decay type. A short average time to fall asleep indicates that the user can fall asleep better under this decay type, and thus it is possible to select the decay type with the shortest average time to fall asleep for the user.

Returning to FIG. 3, in 305, a required amount of change per unit time of the brightness value and/or volume value of the playback device is determined according to the decay type, expected time to fall asleep, and the current volume value and/or current brightness value. The audio playback device can change the volume value according to the required amount of change per unit time of the volume value until it stops playing or shuts down, and the video playback device can change the brightness value and volume value of the playback according to the required amount of change per unit time of the brightness value and the volume value until it stops playing or shuts down. In an embodiment according to the present disclosure, the brightness value and the volume value of the video playback device may also be changed separately. For example, if necessary, it is possible to change the volume value according to the determined amount of change while maintaining the brightness value, and maintain the brightness value when the device stops playing or change the brightness value to zero when the device shuts down.

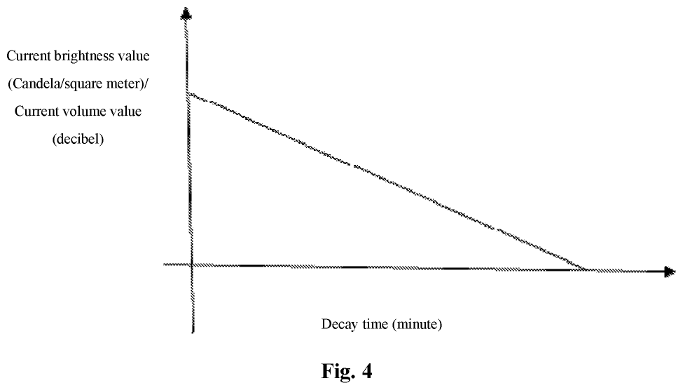

FIG. 4 is a schematic diagram of an exemplary decay type according to an embodiment of the present disclosure.

The decay type can be expressed by a linear function, which can be represented by the following formula:

f(t)=Value1−m*t

where f(t) represents the brightness value or volume value that changes with time, Value1 represents the brightness value or volume value at the time a request for entering the sleep mode is made, t represents time, the coefficient m corresponds to the required amount of change per unit time of the brightness value and/or the volume value, and the coefficient m can be determined according to the decay type, expected time to fall asleep, and the volume value and/or the brightness value at the time the request for entering the sleep mode is made.

Those skilled in the art will understand that the schematic diagram of the decay type is only exemplary and not restrictive.

Although some operations in the aforementioned embodiments are implemented by hardware or software, in general, the operations in the aforementioned embodiments may be implemented in various configurations and frameworks. Therefore, some or all of the operations in the aforementioned embodiments may be implemented by hardware, software, or both. For example, at least some operations in the communication technology can be implemented using the program instruction 122, the operating system 124 (such as a driver for the interface circuit 118), or firmware in the interface circuit 118 of the electronic device 100. Alternatively or in addition, at least some operations in the communication technology may be implemented at a physical layer, such as hardware in the interface circuit 118 of the electronic device 100.

The present disclosure may be realized as any combination of devices, systems, integrated circuits, and computer programs on non-transient computer-readable media. One or a plurality of processors may be realized as an integrated circuit (IC), an application-specific integrated circuit (ASIC) or a large-scale integrated circuit (LSI), a system LSI, a super LSI, or an ultra LSI component that performs some or all of the functions described in the present disclosure.

According to each step of the method of the present disclosure, it may also be executed respectively by a plurality of components included in the device. According to an embodiment, these components can be realized as computer program modules established to realize various steps of the method, and a device including these components may realize the program module structure of the method by computer programs.

The present disclosure includes the use of software, applications, computer programs, or algorithms. Software, application programs, computer programs or algorithms can be stored on a non-transient computer-readable medium, so that a computer with one or a plurality of processors can execute the aforementioned steps and the steps described in the attached drawings. For example, one or more memories save software or algorithms via executable instructions, and one or more processors may associate a set of instructions executing the software or algorithms to enhance security in any number of wireless networks according to the embodiments described in the present disclosure.

Software and computer programs (also called programs, software applications, applications, components, or codes) include machine instructions for programmable processors, and may be realized in high-level procedural languages, object-oriented programming languages, functional programming languages, logic programming languages, or assembly languages or machine languages. The term “computer-readable medium” refers to any computer program product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may include the dynamic random access memory (DRAM), random access memory (RAM), read only memory (ROM), electrically erasable read only memory (EEPROM), compact disk read only memory (CD-ROM) or other optical disk storage devices, magnetic disk storage devices or other magnetic storage devices, or any other medium that can be used to carry or store the required computer-readable program codes in the form of instructions or data structures and can be accessed by a general or special computer or a general or special processor. As used herein, magnetic disks or disks include Compact Discs (CDs), laser disks, optical disks, Digital Versatile Discs (DVDs), floppy disks, and Blu-ray disks, wherein magnetic disks usually copy data magnetically, and disks copy data optically via laser. Combinations of the above are also included in the scope of computer-readable media.

In one or a plurality of embodiments, the use of the words “able”, “can”, “operable as” or “configured as” refers to some devices, logics, hardware and/or components designed to be used in a specified manner. The subject matter of the present disclosure is provided as an example of the apparatus, system, method, and program for performing the features described in the present disclosure. However, in addition to the aforementioned features, other features or modifications can be expected. It can be expected that any emerging technology that may replace any of the aforementioned realization technologies may be used to complete the realization of the components and functions of the present disclosure.

In addition, the above description provides examples without limiting the scope, applicability, or configuration set forth in the claims. Without departing from the spirit and scope of the present disclosure, changes may be made to the functions and layouts of the discussed components. Various embodiments may omit, substitute, or add various processes or components as appropriate. For example, features described with respect to some embodiments may be combined in other embodiments.

Similarly, although operations are depicted in a specific order in the attached drawings, this should not be understood as a requirement that such operations should be executed in the specific order shown or in the sequential order, or that all illustrated operations be executed to achieve the desired result. In some cases, multi-tasking and parallel processing can be advantageous.

1. An electronic device, comprising:
a memory, in which instructions are stored; and
a processor, configured to execute the instructions stored in the memory to cause the electronic device to execute the following operations:
receiving a request for entering a sleep mode;
obtaining expected time to fall asleep;
obtaining current volume value and/or current brightness value of a playback device;
selecting a decay type; and
determining a required amount of change per unit time of the brightness value and/or volume value of the playback device according to the decay type, expected time to fall asleep, and the current volume value and/or current brightness value.

2. The electronic device according to claim 1, wherein the request for entering the sleep mode is received from user input.

3. The electronic device according to claim 1, wherein the request for entering the sleep mode is received from a wearable device that monitors physiological parameters of a user.

4. The electronic device according to claim 1, wherein the expected time to fall asleep is obtained from user input.

5. The electronic device according to claim 1, wherein the processor is further configured to execute the instructions stored in the memory to cause the electronic device to execute the following operation:
obtaining physiological parameter values of a user during the sleep mode as sleep history data from a wearable device that monitors the physiological parameters of the user.

6. The electronic device according to claim 5, wherein the expected time to fall asleep or the decay type is determined based on the sleep history data.

7. The electronic device according to claim 1, wherein the decay type is selected according to user input.

8. The electronic device according to claim 1, wherein the decay types include one or more of a linear decay, a parabolic decay, a Gauss decay, and an exponential decay.

9. An execution method of the electronic device, comprising:
receiving a request for entering a sleep mode;
obtaining expected time to fall asleep;
obtaining current volume value and/or current brightness value of a playback device;
selecting a decay type; and
determining a required amount of change per unit time of the brightness value and/or volume value of the playback device according to the decay type, expected time to fall asleep, and the current volume value and/or current brightness value.

10. The method according to claim 9, wherein the request for entering the sleep mode is received from user input.

11. The method according to claim 9, wherein the request for entering the sleep mode is received from a wearable device that monitors physiological parameters of a user.

12. The method according to claim 9, wherein the expected time to fall asleep is obtained from user input.

13. The method according to claim 9, further comprising:
obtaining physiological parameter values of a user during the sleep mode as sleep history data from a wearable device that monitors the physiological parameters of the user.

14. The method according to claim 13, wherein the expected time to fall asleep or the decay type is determined based on the sleep history data.

15. The method according to claim 9, wherein the decay type is selected according to user input.

16. The method according to claim 9, wherein the decay types include one or more of a linear decay, a parabolic decay, a Gauss decay, and an exponential decay.

17. A non-transitory computer-readable medium having instructions stored therein, when executed by a processor of an electronic device, the instructions causing the electronic device to execute the following operations:
receiving a request for entering a sleep mode;
obtaining expected time to fall asleep;
obtaining current volume value and/or current brightness value of a playback device;
selecting a decay type; and
determining a required amount of change per unit time of the brightness value and/or volume value of the playback device according to the decay type, expected time to fall asleep, and the current volume value and/or current brightness value.
